(19) United States
(12) Patent Application Publication
(10) Pub. No.: US 2025/0052131 A1
(43) Pub. Date: Feb. 13, 2025

(54) TUBING DRAIN FOR TUBING USED WITH DOWNHOLE PUMP

(71) Applicant: Andrew WRIGHT, Nisku (CA)

(72) Inventor: Andrew WRIGHT, Nisku (CA)

(21) Appl. No.: 18/723,343

(22) PCT Filed: Dec. 21, 2022
(86) PCT No.: PCT/CA2022/051883

§ 371 Date: Jun. 21, 2024

Related U.S. Application Data
(60) Provisional application No. 63/293,704, filed on Dec. 24, 2021.

(51) Int. Cl. E21B 34/14; F16K 3/24; F16K 3/30

(52) U.S. Cl. CPC E21B 34/14; F16K 3/24; F16K 3/30; E21B 2200/06

(57) ABSTRACT

An apparatus and method are provided for draining substances from tubing disposed in a wellbore with a downhole pump, the apparatus including a drain valve that operates to drain the tubing into the wellbore and still enable tools to pass through the drain valve to the downhole pump.

### CROSS-REFERENCE TO RELATED APPLICATIONS

This application claims priority of U.S. provisional patent application Ser. No. 63/293,704 filed 24 Dec. 2021, which is incorporated by reference into this application in its entirety.

### TECHNICAL FIELD

The present disclosure is related to the field of tubing drain valves used in downhole pump applications for downhole oil and gas operations.

### BACKGROUND

Pumps and valves located in hard to reach places present maintenance and maintenance downtime issues. Where pumps and valves are used to produce a natural resource such as a hydrocarbon, downtime can result in lost production and increased expenses for workmen and materials.

In particular, downhole production strings including pumps and valves for lifting fluids such as particulate laden liquids and slurries present a maintenance problem. Here, both pumps and valves can lose capacity and in cases be rendered inoperative when conditions including fluid conditions and fluid velocities fall outside an intended operating range. Such unintended operating conditions can foul, plug, and damage equipment.

The oil and gas industry is familiar with these production equipment problems and has in cases benefited from equipment designed to mitigate production process upsets. However, once this industry adopts a particular equipment design, it is slow to consider improvements for reasons including familiarity with existing equipment and the risk associated with using the untested equipment of market newcomers.

Subsurface safety valves (SSSVs) for tubing are well known in the oil and gas industry and provide one of many failsafe mechanisms to prevent the uncontrolled release of wellbore fluids, should a wellbore system experience a loss in containment. Typically, SSSVs comprise a portion of a tubing string set in place during completion of a wellbore. Although a number of design variations are possible for SSSVs, the vast majority are flapper-type valves that open and close in response to longitudinal movement of a flow tube.

Other types of SSSVs can comprise a valve and valve seat configured that can constrict the flow of fluid flowing therethrough. In either configuration, the valve mechanism can be damaged by erosion caused by the fluids flowing through the valve.

Since SSSVs provide a failsafe mechanism, the default positioning of the flapper valve is usually closed in order to minimize the potential for inadvertent release of wellbore fluids. The flapper valve can be opened through various means of control from the earth's surface in order to provide a flow pathway for production to occur. One problem with the prior art safety valves is that once their valve mechanisms are operated, fluid flow through the valve is stopped or severely constricted. Another problem with the prior art safety valves is that the valve mechanisms do not permit downhole tools to be run through the valve to downhole equipment disposed below the valve, such as a downhole pump.

U.S. Pat. No. 11,002,367 issued to Pratt et al. on May 11, 2021 describes a valve system that uses a magnet sleeve to move an intermediate sleeve up and down to open and closing openings in an outer stationary sleeve in line with the production tubing. This system is complicated and must be run down the production tubing with a wireline to align with the stationary sleeve, having packing components above and below the openings in the outer stationary sleeve. In addition, the combination of the intermediate and the magnet sleeve reduce the cross-sectional area of the production tubing that restricts the flow of substances therethrough as well as restricting the type and size of tools that can be run down through the valve system if not eliminating that capability altogether.

It is, therefore, desirable to provide a tubing drain mechanism that overcomes these shortcomings of the prior art.

### SUMMARY

In some embodiments, oil and gas reversible downhole auto tubing drains can normally run above the electrically submersible pump (ESP) but can also be built into the pump. In some embodiments, the drain can come with or without a ceramic plate placed above the tubing drain holes to the annulus for pressure testing the tubing. In an ESP application, a progressive cavity pump application or a sucker rod pump application, a ball can be dropped into the tubing from surface to burst the plate or use pressure from the pump to burst the plate from below, or pressure applied from surface. The valve can be operated via digital sensors or hydraulics or electrical contact. In some embodiments, a magnetic mechanism can be used. When the sensor sees no electricity, a spring disposed within the valve can move the inner sleeve valve to the open position, revealing the drain ports thereby allowing the tubing to drain into the annulus. When the system is energized, meaning there is power, the magnetic system can energize and move the sleeve valve to the closed position, compressing the spring in the process, thereby allowing production to surface again. In other embodiments, the magnetic mechanism and spring can be configured such that the spring urges the sleeve valve to the closed position and moving the sleeve valve to the open position requires energizing the magnetic mechanism to draw the sleeve valve towards to the open position, compressing the spring in the process. In some embodiments, this system can operate similarly with hydraulic, electric or from the sensors in an oil or gas well communicating from surface.

In some embodiments, an apparatus and method can be provided for draining tubing disposed in a wellbore with a downhole pump, the apparatus including a drain valve that operates to drain the tubing into the wellbore and still enable tools to pass through the drain valve to the downhole pump. In some embodiments, the apparatus can be built-in or integral to the downhole pump. In other embodiments, the apparatus can be disposed in the tubing string connected to the downhole pump.

Broadly stated, in some embodiments, a drain valve can be provided for tubing disposed in a wellbore, the tubing connected to a downhole pump disposed in the wellbore, comprising: a tubular body comprising one or more drain ports disposed through a sidewall therethrough, the drain ports configured to provide communications between an interior of the tubing and the wellbore, the tubular body either comprising an upper end and a lower end, each of the upper and lower ends configured to threadably connect with the tubing disposed above and below the tubular body or is disposed within the downhole pump; a sleeve valve disposed within the tubular body, the sleeve valve comprising an inside diameter substantially the same of that of the tubing, the sleeve valve configured to move between a first position, where the sleeve valve closes off the drain ports, and a second position, where the sleeve valve opens the drain ports, the sleeve valve further configured for communication therethrough when the sleeve valve is in both of the first and second positions; an operating mechanism configured to move the sleeve valve between the first position to the second position wherein the interior of the tubing is in communication with the wellbore; and a biasing mechanism configured to keep the sleeve valve in one of the first and second positions.

Broadly stated, in some embodiments, the operating mechanism can comprise a hydraulic fluid mechanism.

Broadly stated, in some embodiments, the biasing mechanism can comprise a spring.

Broadly stated, in some embodiments, the spring can be configured to urge the sleeve valve from the first position to the second position, and wherein the hydraulic fluid mechanism is configured to urge the sleeve valve towards the first position when the hydraulic fluid mechanism is operating and is further configured to let the spring move the sleeve valve towards the second position when the hydraulic fluid mechanism is not operating.

Broadly stated, in some embodiments, the spring can be configured to urge the sleeve valve from the second position to the first position, and wherein the hydraulic fluid mechanism is configured to urge the sleeve valve towards the second position when the hydraulic fluid mechanism is operating and is further configured to let the spring move the sleeve valve towards the first position when the hydraulic fluid mechanism is not operating.

Broadly stated, in some embodiments, the tubular body can be comprised of non-magnetic metal.

Broadly stated, in some embodiments, the operating mechanism can comprise a magnet mechanism.

Broadly stated, in some embodiments, the biasing mechanism can comprise a spring.

Broadly stated, in some embodiments, the spring can be configured to urge the sleeve valve from the first position to the second position, and wherein the magnet mechanism is configured to urge the sleeve valve towards the first position when the magnet mechanism is operating and is further configured to let the spring move the sleeve valve towards the second position when the magnet mechanism is not operating.

Broadly stated, in some embodiments, the magnet mechanism can comprise an electromagnet.

Broadly stated, in some embodiments, the spring can be configured to urge the sleeve valve from the second position to the first position, and wherein the magnet mechanism is configured to urge the sleeve valve towards the second position when the magnet mechanism is operating and is further configured to let the spring move the sleeve valve towards the first position when the magnet mechanism is not operating.

Broadly stated, in some embodiments, the magnet mechanism can comprise an electromagnet.

Broadly stated, in some embodiments, the electromagnet can be configured to operate in response to an operate control signal or when electrical power to the downhole pump is disconnected.

Broadly stated, in some embodiments, a method can be provided for draining tubing disposed in a wellbore, the tubing connected to a downhole pump disposed in the wellbore, the method comprising: placing a drain valve in the tubing disposed in the wellbore, the drain valve comprising: a tubular body comprising one or more drain ports disposed through a sidewall therethrough, the drain ports configured to provide communications between an interior of the tubing and the wellbore, the tubular body either comprising an upper end and a lower end, each of the upper and lower ends configured to threadably connect with the tubing disposed above and below the tubular body or is disposed within the downhole pump, a sleeve valve disposed within the tubular body, the sleeve valve comprising an inside diameter substantially the same of that of the tubing, the sleeve valve configured to move between a first position, where the sleeve valve closes off the drain ports, and a second position, where the sleeve valve opens the drain ports, the sleeve valve further configured for communication therethrough when the sleeve valve is in both of the first and second positions, an operating mechanism configured to move the sleeve valve between the first position to the second position wherein the interior of the tubing is in communication with the wellbore, and a biasing mechanism configured to keep the sleeve valve in one of the first and second positions; and using the operating mechanism, moving the sleeve valve from the first position to the second position whereby fluid disposed in the tubing drains through the drain ports into the wellbore.

### BRIEF DESCRIPTION OF THE DRAWINGS

FIG. 1 is a side elevation cross-section view depicting one embodiment of a tubing drain with a sleeve valve shown in a closed position.

FIG. 2 is a side elevation cross-section view depicting the tubing drain of Figure with the sleeve valve shown in an open position.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments, but is not necessarily included. Thus, the present technology can include a variety of combinations and/or integrations of the embodiments described herein.

Unless otherwise specified, use of the terms “connect”, “engage”, “couple”, “attach”, or any other like term describing an interaction between elements is not meant to limit the interaction to direct interaction between the elements and may also include indirect interaction between the elements described.

Unless otherwise specified, use of the terms “up”, “upper”, “upward”, “uphole”, “upstream”, or other like terms shall be construed as generally toward the surface of the formation; likewise, use of the terms “down”, “lower”, “downward”, “downhole”, or other like terms shall be construed as generally toward the bottom, terminal end of a well, regardless of the wellbore orientation. Use of any one or more of the foregoing terms shall not be construed as denoting positions along a perfectly vertical or horizontal axis. Unless otherwise specified, use of the term “subterranean formation” shall be construed as encompassing both areas below exposed earth and areas below earth covered by water, such as ocean or fresh water.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

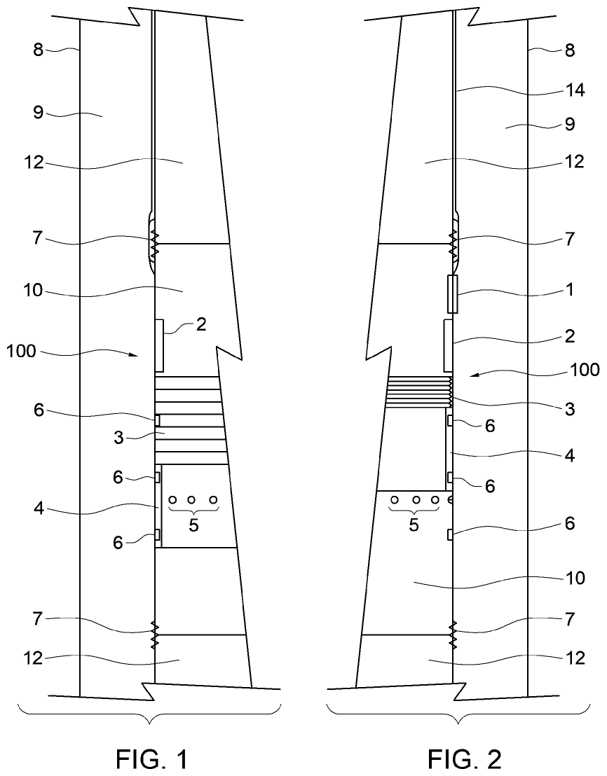

Referring to FIGS. 1 and 2, one embodiment of tubing drain valve 10 is shown in wellbore 9 that is encased by casing 8, as well known to those skilled in the art. In some embodiments, drain valve 100 can comprise of tubular body 10 that can couple tubing 12 disposed above and below tubular 10 via threaded connections 7. In some embodiments, tubular body 10 can comprise a plurality of drain ports 5 disposed through tubular body 10 wherein fluid can flow from within tubular body 10 through drain ports 5 into wellbore 9. In some embodiments, drain valve 100 can comprise of annular sleeve valve 4 slidably disposed within tubular body 10.

Referring to FIG. 1, sleeve valve 4 is shown in a first position whereby drain ports 5 are covered by sleeve valve 4 thereby closing off drain ports 5 so that no fluid can flow therethrough from within tubular body 10 into wellbore 9. In some embodiments, sleeve valve 4 can comprise an inside diameter substantially same as tubing 12 whereby there are no obstructions within drain valve 100 to provide unobstructed fluid flow therethrough or for running downhole tools through drain valve 100. In some embodiments, sleeve valve 4 can be biased to the first or closed position by a biasing mechanism. In the illustrated embodiments, the biasing mechanism can comprise of spring 3 that is configured to urge or bias sleeve valve 4 towards the first or closed position although other functionally equivalent mechanisms can be used as the biasing mechanism as well known to those skilled in the art.

In some embodiments, sleeve valve 4 can comprise seals 6 to seal off drain ports 5 from the interior of tubular body 10 when sleeve valve 4 is in the first or closed position. To permit the draining of fluid within tubular body 10, sleeve valve 4 can move from the first or closed position to a second or open position. In the illustrated embodiments, the first position is below or downhole from the second position such that sleeve valve 4 moves upwards to move to the second or open position although, in other embodiments, this configuration can be reversed such that sleeve valve 4 moves downwards to move to the second or open position.

In some embodiments, an operating mechanism can be used to move sleeve valve 4 from the first position to the second position. In some embodiments, the operating mechanism can comprise of electromagnet 2. In this embodiment, tubular body 10 must comprise of a non-magnetic metal such as non-magnetic metal alloys, such as stainless steel, or other functionally equivalent metals or metal alloys as well known to those skilled in the art. In this embodiment, sleeve valve 4 can comprise of a magnetic material comprising one or more of ferrous metals and alloys as well known to those skilled in the art. In some embodiments, to move sleeve valve 4 from the first position to the second position, electromagnet 2 can be energized and, thereby, urge sleeve valve 4 towards electromagnet 2, comprising spring 3 in the process. As sleeve valve 4 moves towards electromagnet 2, drain ports 5 become exposed so they can permit fluid flow therethrough from within tubular body 10 into wellbore 9. When electromagnet 2 is de-energized, the biasing mechanism, spring 3 in the illustrated embodiment, urges sleeve valve 4 from the second or open position to the first or closed position. With this configuration of drain valve 100, there are no obstructions therein so that fluid can flow freely through tubular body 10 and sleeve valve 4 regardless of whether sleeve valve 4 is in the first or second position. Furthermore, downhole tools, as well known to those skilled in the art, can still be run through drain valve 100 regardless of whether sleeve valve 4 is in the first or second position.

In some embodiments, electromagnet 2 can be operated via power pack 1 disposed on drain valve 100. Power pack 1 can be provided with electrical power via cable 14 disposed along tubing 12. Cable 14 can also comprise electrical conductors to send electrical control signals to a circuit board disposed within power pack 1. In some embodiments, electromagnet 2 can be operated by an operate control signal provided by a variable frequency drive-controlled progressive cavity pump or pump jack located on the ground surface, the operate control signal transmitted on cable 14 or via wireless digital signal transmitted from the surface to the circuit board.

In some embodiments, the circuit board can be configured to provide electrical power to electromagnet 2 to move sleeve valve 4 to the second or open position in response to the operate control signal received via cable 14, the circuit board configured to disconnect electrical power to electromagnet 2 to permit sleeve valve 4 to return to the first or closed position in response a disconnect control signal received via cable 14 or via wireless digital signal transmitted from the surface to the circuit board, or in response to the operate control signal being turned off or disconnected to the circuit board. In other embodiments, power pack 1 can comprise a battery configured to power electromagnet 2 as described above. In these embodiments, the operate control signal and the disconnect control signal can be provided along cable 14. In some embodiments, drain valve 100 can be configured to operate with an electrically submersible pump (“ESP”) such that when electrical power is disconnected from the ESP to stop its operation, the circuit board can be configured to detect the disconnection of electrical power to the ESP. In this case, when the circuit board detects the disconnection of electrical power, the circuit board can then connect electrical power to electromagnet 2 to move sleeve valve 4 to the second or open position.

In some embodiments, the circuit board in power pack 1 can be configured to receive wireless operate and disconnect control signals sent by a wireless transmitter. In these embodiments, electrical power for electromagnet 2 can be provided by cable 14 or wireless digital signal transmitted from the surface to the circuit board, or by a battery disposed within power pack 1.

In some embodiments, the operating mechanism to move sleeve valve 4 can comprise of a hydraulic mechanism in place of electromagnet 2 and power pack 1, wherein the hydraulic mechanism can be configured to move sleeve valve 4 between the first or closed position and the second or open position.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A drain valve for tubing disposed in a wellbore, the tubing connected to a downhole pump disposed in the wellbore, the drain valve comprising:
a) a tubular body comprising one or more drain ports disposed through a sidewall therethrough, the drain ports configured to provide communications between an interior of the tubing and the wellbore, the tubular body either comprising an upper end and a lower end, each of the upper and lower ends configured to threadably connect with the tubing disposed above and below the tubular body or is disposed within the downhole pump;
b) a sleeve valve disposed within the tubular body, the sleeve valve comprising an inside diameter substantially the same of that of the tubing, the sleeve valve configured to move between a first position, where the sleeve valve closes off the drain ports, and a second position, where the sleeve valve opens the drain ports, the sleeve valve further configured for communication therethrough when the sleeve valve is in both of the first and second positions;
c) an operating mechanism configured to move the sleeve valve between the first position to the second position wherein the interior of the tubing is in communication with the wellbore; and
d) a biasing mechanism configured to keep the sleeve valve in one of the first and second positions.

2. The drain valve as set forth in claim 1, wherein the operating mechanism comprises a hydraulic fluid mechanism.

3. The drain valve as set forth in claim 2, wherein the biasing mechanism comprises a spring.

4. The drain valve as set forth in claim 3, wherein the spring is configured to urge the sleeve valve from the first position to the second position, and wherein the hydraulic fluid mechanism is configured to urge the sleeve valve towards the first position when the hydraulic fluid mechanism is operating and is further configured to let the spring move the sleeve valve towards the second position when the hydraulic fluid mechanism is not operating.

5. The drain valve as set forth in claim 3, wherein the spring is configured to urge the sleeve valve from the second position to the first position, and wherein the hydraulic fluid mechanism is configured to urge the sleeve valve towards the second position when the hydraulic fluid mechanism is operating and is further configured to let the spring move the sleeve valve towards the first position when the hydraulic fluid mechanism is not operating.

6. The drain valve as set forth in claim 1, wherein the tubular body is comprised of non-magnetic metal.

7. The drain valve as set forth in claim 6, wherein the operating mechanism comprises a magnet mechanism.

8. The drain valve as set forth in claim 7, wherein the biasing mechanism comprises a spring.

9. The drain valve as set forth in claim 8, wherein the spring is configured to urge the sleeve valve from the first position to the second position, and wherein the magnet mechanism is configured to urge the sleeve valve towards the first position when the magnet mechanism is operating and is further configured to let the spring move the sleeve valve towards the second position when the magnet mechanism is not operating.

10. The drain valve as set forth in claim 9, wherein the magnet mechanism comprises an electromagnet.

11. The drain valve as set forth in claim 10, wherein the electromagnet is configured to operate in response to an operate control signal or when electrical power to the downhole pump is disconnected.

12. The drain valve as set forth in claim 8, wherein the spring is configured to urge the sleeve valve from the second position to the first position, and wherein the magnet mechanism is configured to urge the sleeve valve towards the second position when the magnet mechanism is operating and is further configured to let the spring move the sleeve valve towards the first position when the magnet mechanism is not operating.

13. The drain valve as set forth in claim 12, wherein the magnet mechanism comprises an electromagnet.

14. The drain valve as set forth in claim 13, wherein the electromagnet is configured to operate in response to an operate control signal or when electrical power to the downhole pump is disconnected.

15. A method for draining tubing disposed in a wellbore, the tubing connected to a downhole pump disposed in the wellbore, the method comprising:
a) placing a drain valve in the tubing disposed in the wellbore, the drain valve comprising:
i) a tubular body comprising one or more drain ports disposed through a sidewall therethrough, the drain ports configured to provide communications between an interior of the tubing and the wellbore, the tubular body either comprising an upper end and a lower end, each of the upper and lower ends configured to threadably connect with the tubing disposed above and below the tubular body or is disposed within the downhole pump,
ii) a sleeve valve disposed within the tubular body, the sleeve valve comprising an inside diameter substantially the same of that of the tubing, the sleeve valve configured to move between a first position, where the sleeve valve closes off the drain ports, and a second position, where the sleeve valve opens the drain ports, the sleeve valve further configured for communication therethrough when the sleeve valve is in both of the first and second positions,
iii) an operating mechanism configured to move the sleeve valve between the first position to the second position wherein the interior of the tubing is in communication with the wellbore, and
iv) a biasing mechanism configured to keep the sleeve valve in one of the first and second positions; and
b) using the operating mechanism, moving the sleeve valve from the first position to the second position whereby fluid disposed in the tubing drains through the drain ports into the wellbore.
